(19) United States
(12) Patent Application Publication
(10) Pub. No.: US 2007/0169636 A1
(43) Pub. Date: Jul. 26, 2007

(54) Pizza pan

(76) Inventors: Edward Scott Carlson, Delmont, PA (US); Donald V. Edwards, Harrison City, PA (US)

Correspondence Address: JAMES RAY & ASSOCIATES, 2640 PITCAIRN ROAD, MONROEVILLE, PA, 15146, US

(21) Appl. No.: 11/657,802

(22) Filed: Jan. 25, 2007

Related U.S. Application Data
(60) Provisional application No. 60/761,990, filed on Jan. 25, 2006.

(51) Int. Cl. A47J 31/00

(52) U.S. Cl. 99/279

(57) ABSTRACT

An apparatus for at least one of supporting and containing a preselected food product to be at least one of baked, cut and served. The apparatus comprises a first member having a first predetermined shape and a first predetermined size, such first member having a plurality of projections extending upwardly. There is a second member having a second predetermined shape and a second predetermined size for engagement with the first member. The second member has a plurality of apertures formed therein for permitting the plurality of projections to extend therethrough when the second member is placed on top of the first member. There are also a plurality of grooves disposed adjacent an upper surface of the second member extending from an outer edge of the second member to an axially opposed outer edge of the second member for enabling a cutting means to pass completely through such preselected food product.

### CROSS REFERENCE TO RELATED APPLICATIONS

This application is closely related to and claims benefit from U.S. Provisional Application Ser. No. 60/761,990 filed Jan. 25, 2006.

### FIELD OF THE INVENTION

The present invention relates, in general, to a pan or serving tray for heating and serving pizza and other dough based products, and, more particularly, the present invention relates to a two part pan or serving tray that incorporates grooves at designated locations that enable the user to completely cut through the crust every time and projections that prevent such pizza from moving while being cut.

### BACKGROUND OF THE INVENTION

In our present society one of the most commonly consumed food is pizza. Pizza rivals the hamburger and hot dog as being the typical American food. Traditional methods of cooking or baking a pizza and other dough based products consist of either forming dough or placing a preformed crust into a pan, applying the toppings or placing a frozen pizza in a pan and then baking the pizza. The pan is then removed from the oven and either the pizza is cut directly in the pan and the individual pieces removed or the entire pizza is slid out of the pan and then the pizza is cut, typically on a counter top or in a serving tray. When cutting pizza in traditional pans (pans with an exterior vertical side) with a wheel or knife the circular blade rarely ever fully cuts completely through the crust because there is a round blade that is being pushed or pulled into a square corner. Another common problem that occurs when cutting pizzas in pans or on flat surfaces such as pizza stones is that when rolling a circular blade directly into the crust the entire pizza tends to want to move in a horizontal plane away from the cutting or even out of the pan altogether.

To avoid this problem many commercial bakeries will frequently cut the pizza directly in the box for shipment. As a result of the existing methods, pizzas are not cut throughout but the pizza is partially connected at the crust. It is necessary to remove the adjacent pieces at the same time and attempt to pull them apart or try to do this with a knife to further cut the crust before the pieces are removed. As a result some toppings may fall onto the counter top or back in the box and the user may end up with a piece of pizza without toppings and generally a sticky mess.

### SUMMARY OF THE INVENTION

The present invention provides an apparatus for at least one of supporting and containing a preselected food product to be at least one of baked, cut and served. The apparatus comprises a first member having a first predetermined shape and a first predetermined size, such first member having a plurality of projections extending upwardly. There is a second member having a second predetermined shape and a second predetermined size for engagement with the first member. The second member has a plurality of apertures formed therein for permitting the plurality of projections to extend therethrough when the second member is placed on top of the first member. There is also a means disposed adjacent an upper surface of the second member extending from an outer edge of said second member to an axially opposed outer edge of said second member for enabling a cutting means to pass completely through such preselected food product.

### OBJECTS OF THE INVENTION

It is, therefore, one of the primary objects of the present invention to provide an apparatus which enables the user to cut completely through the crust of a pizza.

It is another object of the present invention to provide an apparatus which enables the user to cut perfectly shaped pizza slices.

Another object of the present invention is to provide an apparatus which can be used with existing equipment, such as pizza wheels, knives and rocker cutters.

It is still another object of the present invention to provide an apparatus which is easy for the user to use.

Still another object of the present invention is to provide an apparatus that is inexpensive to manufacture.

Yet, another object of the present invention is to provide an apparatus which can be used for a variety of baking needs.

Another object of the present invention is to provide an apparatus which will maintain the position of the food product in the pan or tray while being cut.

Still another object of the present invention is to provide an apparatus wherein the food product can either be cut in the heated pan or on a serving tray.

Another object of the present invention is to provide a two part apparatus in which the food product can be at least one of baked, cut and served.

Yet, another object of the present invention is to provide an apparatus in which the pizza after it is cut can be slid off of the upper tray into a box for delivery.

Still another object of the present invention is to provide an apparatus in which the cutting grooves extend through to the edge of the tray.

In addition to the numerous objects and advantages of the present invention which have been described with some degree of particularity above, it should be both noted and understood that a number of other important objects and advantages of the invention will become more readily apparent to those persons who are skilled in the relevant art from the following more detailed description of the invention, particularly, when such detailed description is taken in conjunction with the appended claims.

### BRIEF DESCRIPTION OF THE DRAWINGS

FIG. 1 is a plan view of one member of the apparatus according to an embodiment of the invention.

FIG. 2 is a side view of the apparatus shown in FIG. 1.

FIG. 3 is a plan view of another member of the apparatus according to an embodiment of the invention.

FIG. 4 is a side view of the member of the apparatus shown in FIG. 3.

FIG. 5 is a perspective view of the member shown in FIG. 1 showing a different arrangement of the grooves disposed on the surface of the member.

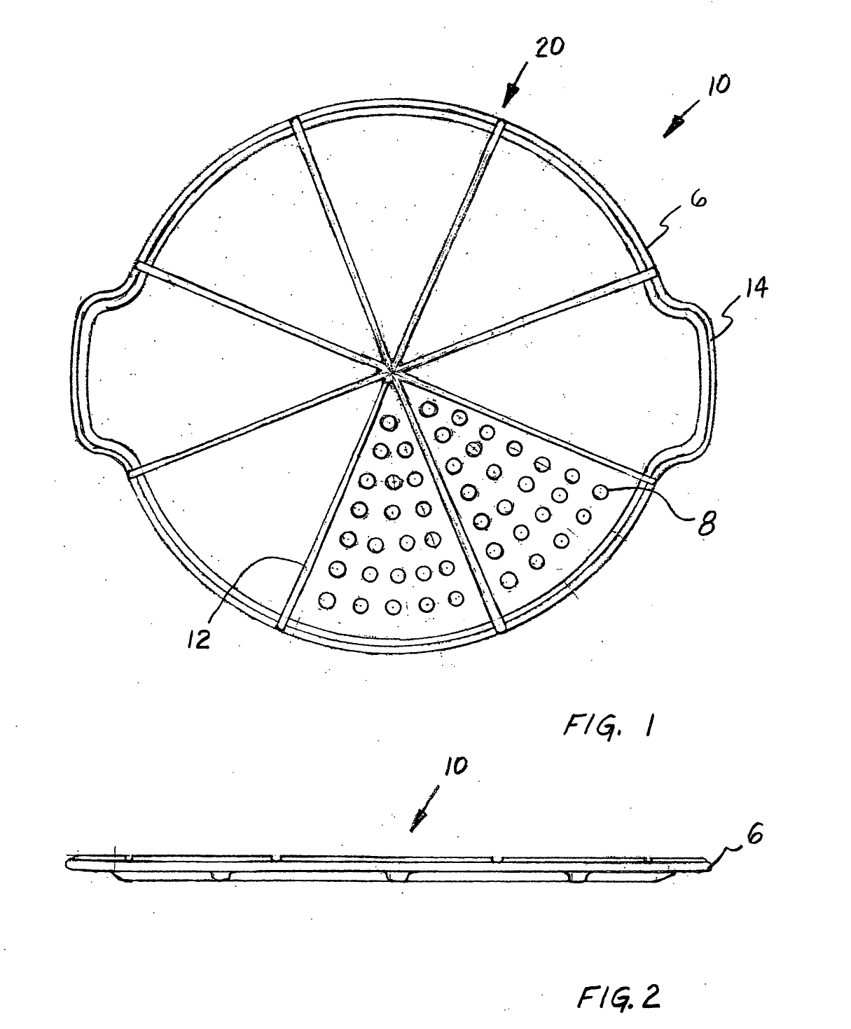

### BRIEF DESCRIPTION OF THE PRESENTLY PREFERRED AND VARIOUS ALTERNATE EMBODIMENTS OF THE PRESENT INVENTION

Prior to proceeding to the more detailed description of the present invention, it should be noted that for the sake of clarity in understanding the invention, identical components with identical functions have been designated with identical reference numerals throughout the drawing Figures.

Illustrated in the drawing Figures is an apparatus, generally designated 10. Although most of the discussion is devoted toward the use of a round pan, it is within the scope of the invention that such pan could have various shapes. The pan can be round, rectangular, hexagonal or octagonal. It is presently preferred, however, that such pan be round.

The present invention provides an apparatus 10 for at least one of supporting and containing a preselected food product to be at least one of baked, cut and served. The apparatus comprises a first member 2 having a first predetermined shape and a first predetermined size, such first member having a plurality of projections 4 extending upwardly. There is a second member 6 having a second predetermined shape and a second predetermined size for engagement with the first member 2. The second member 6 has a plurality of apertures 8 formed therein for permitting the plurality of projections 4 to extend therethrough when the second member 6 is placed on top of the first member 2. There is also a means, generally designated 20, disposed adjacent an upper surface of the second member 6 extending from an outer edge of the second member 6 to an axially opposed outer edge of the second member 6 for enabling a cutting means to pass completely through such preselected food product and for guiding the cutting means.

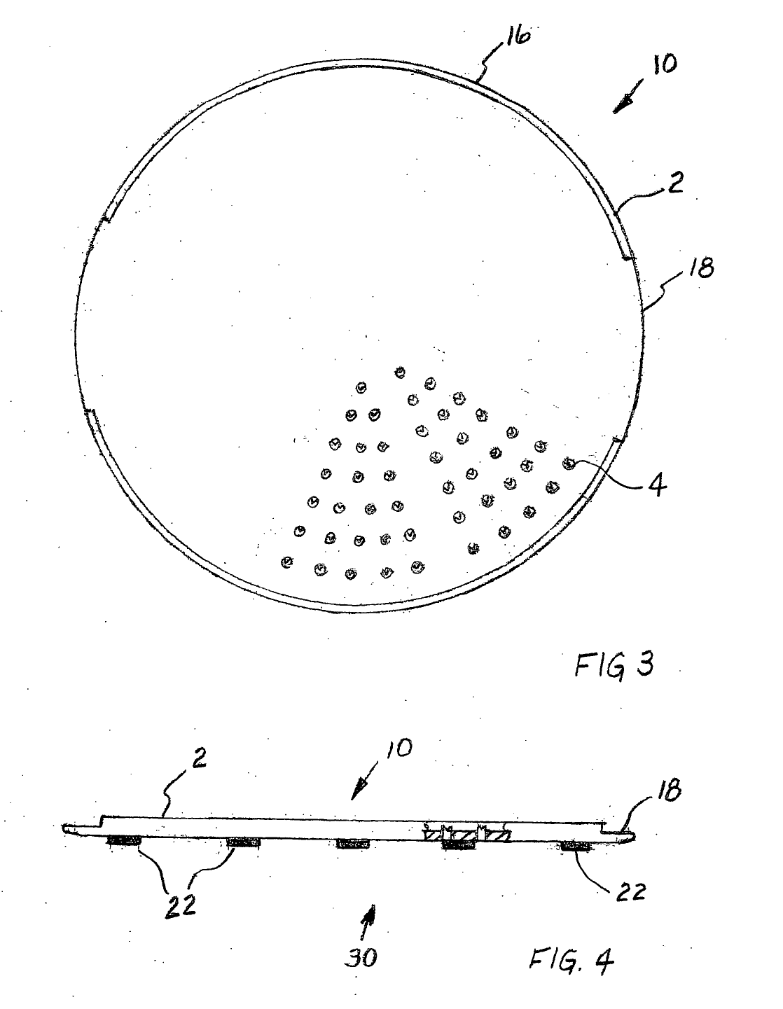

The apertures 8 are disposed uniformly over the surface of the second member 6 so as to correspond to the projections 4 which are also uniformly distributed over the surface of the first member 2 although they are only shown in several segments as an example on FIGS. 1 and 3.

In a preferred embodiment of the invention such means 20 includes a plurality of elongated grooves 12 extending from a point through an outer edge of the second member 6 to a point through an axially opposed outer edge of the second member 6 and from an upper surface thereof to a first predetermined depth, the plurality of the elongated grooves 12 enabling the cutting means, generally this would be a pizza wheel, to pass completely through such preselected food product. Since the elongated grooves 12 extend through the outer edge of the second member 6 the pizza wheel can follow the elongated groove and completely cut through the pizza. The plurality of elongated grooves 12 extend from an upper surface thereof to depth sufficient for the pizza wheel to cut completely through such pizza crust.

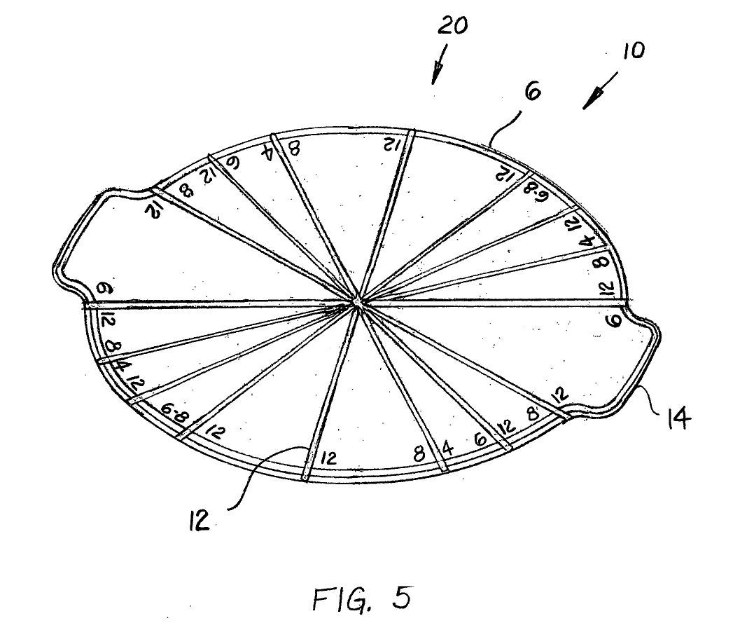

Illustrated in FIG. 1 is the second member having the plurality of elongated grooves 12 being uniformly formed therein so as to provide eight equal slices of pizza. However, it is within the concept of the invention that such elongated grooves 12 could be disposed as illustrated in FIG. 5 wherein the elongated grooves 12 are not uniformly disposed but are arranged so that such pizza can be cut into various sizes. As shown in FIG. 5, the pizza could be cut into 4, 6, 8 or 12 slices. It is also possible to mix and match the grooves 12 so as to permit cutting some pieces in twelfths, others into eights or sixths while still others in fourths. The numbers shown on the outer edge of the second member on FIG. 5 show the different size slices that can be made by using the arrangement of elongated grooves 12 in this embodiment. This gives the user the ability to uniformly cut through the pizza and provide slices that are adaptable for small appetites or for larger appetites.

It is still within the concept of the invention that such elongated grooves 12 could be arranged in a mode that is different from the arrangements shown in FIGS. 1 and 5 so as to add additional grooves or have the grooves arranged differently.

Thus, under a preferred method of the present invention a pizza would be placed on the second member 6 and then put in the oven to bake. Once it is baked the second member is removed from the oven with the baked pizza on it and placed on top of such first member 2. The projections 4 disposed on the first member 2 project through the apertures 8 of the second member 6 thereby engaging the bottom crust of the pizza. The projections 4 have a an upper surface that engages the bottom portion of the pizza thereby preventing the pizza from moving during the cutting operation. The upper surface may be just a point or even several points and may have a hole disposed in such upper surface. It could also have a variety of shapes like conical, triangular, rectangular or half moon. Then using a pizza wheel or another cutting means the pizza is cut along the elongated grooves 12 which permits the pizza to be cut completely through the crust and which also provides the user with the ability to cut uniform pieces of pizza. It should be noted that the elongated grooves 12 extend across the second member from an outer edge portion of the second member 6 to an axially opposed outer edge.

It is within the concept of the invention that a pizza could be placed in the oven and baked on both such first member 2 and such second member 6 rather than just baking on the second member as described above. The main criteria for this would be that such first member 2 also be made of a material that can withstand the oven temperatures required to bake a pizza. It is also within the concept of the invention that a pizza could be baked on a completely different pan and then placed on the present apparatus 10 for cutting and serving. It is still within the concept of the invention that such pizza could be baked on the second member 6 and then cut and served without placing the second member 6 on the first member 2.

The fact that the second member 6 has perforations 8 disposed therein can enhance even baking by allowing moisture to escape through the perforations thereby providing the pizza with a crispy crust.

It is also presently preferred that such first predetermined shape of the first member 2 and the second predetermined shape of such second member 6 are similar and as stated previously are substantially circular.

Further, such second member 6 further includes handles 14 that are disposed on diametrically opposed portions of the second member 6. The handles 14 permit easy handling of the tray with the pizza on it. Such first member 2 has a small ridge 16 around most of the first member 2; however, the ridge 16 has openings 18 on diametrically opposed portions of such first member 6 that coincide with the handles 14 when such second member 6 is placed on top of such first member 2.

The second member 6 provides a substantially flat surface so as to permit the pizza once it is cooked and cut to slide off the pan when desired. This could be of importance if the present invention is used in a commercial pizza shop wherein the pizza could be slid off the second member 6 and into a box for delivery to a customer.

It is also an embodiment of the invention that such first member 2 further includes a means, generally designated 30, disposed on a bottom surface of the first member 2 to prevent such apparatus 10 from moving when such preselected food product is being cut. Such means 30 disposed on the bottom surface of the first member 2 is for preventing such apparatus 10 from moving when such preselected food product is being cut. Such means 30 includes a non slip surface 22. Such nonslip surface 22 could be a plurality of foot like members 22 that are disposed uniformly around the bottom of the first member 2 as shown in FIG. 4 or such nonslip surface 22 could be disposed across the entire bottom of the first member 2.

Such first member can be made of one of metal, plastic, ceramic, fluorocarbon, clay, paper, stone, silicone, glass and combinations thereof. It is presently preferred that such first member 2 is made of plastic and that such plastic is injection molded. Such second member is made of one of metal, plastic, ceramic, fluorocarbon, clay, paper, stone, silicone, glass and combinations thereof. It is presently preferred that such second member 6 is made of metal.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. An apparatus for at least one of supporting and containing a preselected food product to be at least one of baked, cut and served, said apparatus comprising:
(a) a first member having a first predetermined shape and a first predetermined size, said first member having a plurality of projections extending upwardly;
(b) a second member having a second predetermined shape and a second predetermined size for engagement with said first member, said second member having a plurality of apertures formed therein for permitting said plurality of projections to extend therethrough when said second member is placed on top of said first member; and (c) a means disposed adjacent an upper surface of said second member extending from an outer edge of said second member to an axially opposed outer edge of said second member for enabling a cutting means to pass completely through such preselected food product.

2. The apparatus, according to claim 1, wherein said means includes a plurality of elongated grooves extending from an outer edge of said second member to an axially opposed outer edge of said second member and from an upper surface thereof to a first predetermined depth, said plurality of said elongated grooves enabling a cutting means to pass completely through such preselected food product.

3. The apparatus, according to claim 1, wherein said preselected food product is pizza.

4. The apparatus, according to claim 3, wherein said projections have an upper surface for engaging a bottom portion of a pizza crust and thereby preventing such pizza from moving while being cut.

5. The apparatus, according to claim 1, wherein said first predetermined shape and said second predetermined shape are similar.

6. The apparatus, according to claim 5, wherein said first predetermined shape and said second predetermined shape are substantially circular.

7. The apparatus, according to claim 6, wherein said second member further includes handles disposed on diametrically opposite portions of said second member.

8. The apparatus, according to claim 1, wherein said first member further includes a means disposed on a bottom surface of said first member to prevent said apparatus from moving when such preselected food product is being cut.

9. The apparatus, according to claim 8, wherein said means disposed on said bottom surface of said first member to prevent said apparatus from moving when such preselected food product is being cut includes a nonslip surface.

10. The apparatus, according to claim 1, wherein said first member is made of one of metal, plastic, ceramic, fluorocarbon, clay, paper, stone, silicone, glass and combinations thereof.

11. The apparatus, according to claim 10, wherein said first member is made of plastic.

12. The apparatus, according to claim 11, wherein said plastic is injection molded.

13. The apparatus, according to claim 1, wherein said second member is made of one of metal, plastic, ceramic, fluorocarbon, clay, paper, stone, silicone, glass and combinations thereof.

14. The apparatus, according to claim 13, wherein said second member is made of metal.

15. The apparatus, according to claim 3, wherein such pizza is baked on said second member.

16. The apparatus, according to claim 15, wherein said second member having such pizza baked thereon is placed on said first member so that such pizza can be cut easily into slices.

17. The apparatus, according to claim 7, wherein apparatus has an alignment means for aligning said second member on said first member.

18. The apparatus, according to claim 17, wherein said alignment means includes diametrically opposed openings on a ridge member disposed on a surface of said first member, said diametrically opposed openings for receiving said handle members of said second member so as to properly align said second member with said first member.
